(19) United States
(12) Patent Application Publication
(10) Pub. No.: US 2003/0016626 A1
(43) Pub. Date: Jan. 23, 2003

(54) Controlling levels of traffic in a telecommunications network, and a network node therefor

(76) Inventors: Ko Lagerberg, Hengelo (NL); Peter Leijdekkers, Enschede (NL); Miroslav Zivkovic, Enschede (NL)

Correspondence Address: Docket Administrator (Room 3J-219), Lucent Technologies Inc., 101 Crawfords Corner Road, Holmdel, NJ, 07733-3030, US

(21) Appl. No.: 10/170,908

(22) Filed: Jun. 13, 2002

(30) Foreign Application Priority Data
Jul. 19, 2001 (EP) 01306230.2

(51) Int. Cl. G01R 31/08

(52) U.S. Cl. 370/230.1; 370/468

(57) ABSTRACT

A telecommunications network includes nodes and a controller operative to control levels of best-effort traffic transmitted from those nodes so as to keep bandwidth available for traffic sent with a predetermined quality of service.

### CROSS REFERENCE TO RELATED APPLICATION

This application claims priority of European Application No. 01306230.2 filed on Jul. 19, 2001.

### BACKGROUND OF THE INVENTION

1. Field of the Invention

The present invention relates to a telecommunications network, a network node therefor and a method of controlling levels of best-effort traffic.

2. Description of Related Art

Modern local area networks provide support for real-time multimedia and/or business critical applications, for example video conferencing. These Quality of Service (QoS)-enabled applications typically reserve a portion of the available bandwidth prior to a service/application session, and rely on the availability of the bandwidth throughout the session. The telecommunications network guarantees this bandwidth availability by restricting the throughput of other applications that do not have these QoS demands. The traffic generated by these non-QoS applications is called best effort traffic.

In single shared-medium networks such as shared Ethernet (CSMA/CD(carrier sense multiple access/collision detect)) or wireless LAN (CSMA/CA(carrier sense multiple access/collision avoidence)), QoS traffic is insufficiently protected from best effort traffic within the same physical network. Although a QoS-aware application can reserve bandwidth using network operating system functions, there is no distinction between QoS traffic and best effort traffic on medium access level. Since nodes sending best effort traffic are not aware of any bandwidth that is reserved or used by other nodes, some nodes can even consume all the network bandwidth, leaving QoS applications without the possibility of using any reservable bandwidth at all. This is illustrated in FIG. 1 below. When, for example, nodes 2, 3 and 4 are sending a large amount of best effort traffic over the shared medium, QoS traffic from node 1 which should be sent with acceptable quality of service is jeopardized.

The problem described above has to date not been satisfactorily solved. In most ordinary (i.e. switched) LANs the problem does not occur since all nodes have a direct non-shared connection with sufficient bandwidth to a QoS-aware switch. At the switch best effort traffic is dropped when throughput restrictions are exceeded. Therefore a commonly proposed remedy for the problem described above is to change the network architecture from shared to switched LAN. This is however not always desirable (e.g. legacy LANs) or possible (e.g. wireless LANs).

Some earlier attempts have been made to address the problem. Internet Engineering Task Force (IETF) Request for Comments (RFC) No. 2814 describes a Bandwidth Manager protocol, which can be used in combination with RSVP to perform bandwidth reservations in a LAN segment. It is however ineffective on shared LANs. Another IETF RFC No. 2816 briefly mentions the problem but proposes segment switching. U.S. Pat. No. 6,049,549 (Adaptive Media Control) describes an admission control mechanism for wired LANs. The solution is session-based and requires changes in the (already standardized) MAC layer and application, which is problematic.

### SUMMARY OF THE INVENTION

The present invention provides a telecommunications network comprising a plurality of nodes and a controller operative to control levels of best-effort traffic transmitted from nodes so as to keep bandwidth available for traffic sent with a predetermined quality of service.

In its preferred embodiments, the present invention advantageously provides guarantees for QoS traffic in shared medium networks. This allows network equipment vendors to offer total QoS solutions, even within a shared medium network. The quality of real-time and multimedia applications is enhanced, and business-critical applications get the priority they need on the network. The present invention in its preferred embodiments is transparent to applications, i.e. an application does not need to be changed to benefit. The present invention in its preferred embodiments does not require any changes to the MAC layer either.

Preferably at least some nodes include a respective regulator of best effort traffic, said regulators being controlled by best-effort traffic level control signals set by the controller. Preferably all the nodes or at least substantially all the nodes include such regulators.

Preferably the regulators are controlled by a common best-effort traffic level control signal so as to set the maximum level of best-effort traffic sent per unit time by their respective nodes to be the same level.

Alternatively preferably the regulators are controlled by respective best-effort traffic level control signals so as to set the maximum level of best-effort traffic which can be sent per unit time dependent on the amounts of data waiting at nodes to be sent.

The present invention also provides a method of controlling levels of best-effort traffic transmitted from nodes in a telecommunications network so as to keep bandwidth available for traffic sent with a predetermined quality of service by providing a controller of best-effort traffic levels.

Preferably the controller sends control signals to the nodes, the nodes being provided with regulators controlled by the control signals and operative to limit the level of best-effort traffic per unit time sent by the respective node.

The present invention also provides a network node for a telecommunications network, the node comprising a regulator operative under the control of a received control signal to limit the level of best-effort traffic sent by the node per unit time so as to keep bandwidth available for traffic to be sent with a predetermined quality of service.

### BRIEF DESCRIPTION OF THE DRAWINGS

A preferred embodiment of the present invention will now be described by way of example and with reference to the Figures, in which:

FIG. 1 is a schematic illustration of a known telecommunications network (prior art),

FIG. 2 is a schematic illustration of a telecommunications network according to an embodiment of the present invention, and

FIG. 3 is an illustration of possible regulator settings in the telecommunications network shown in FIG. 2.

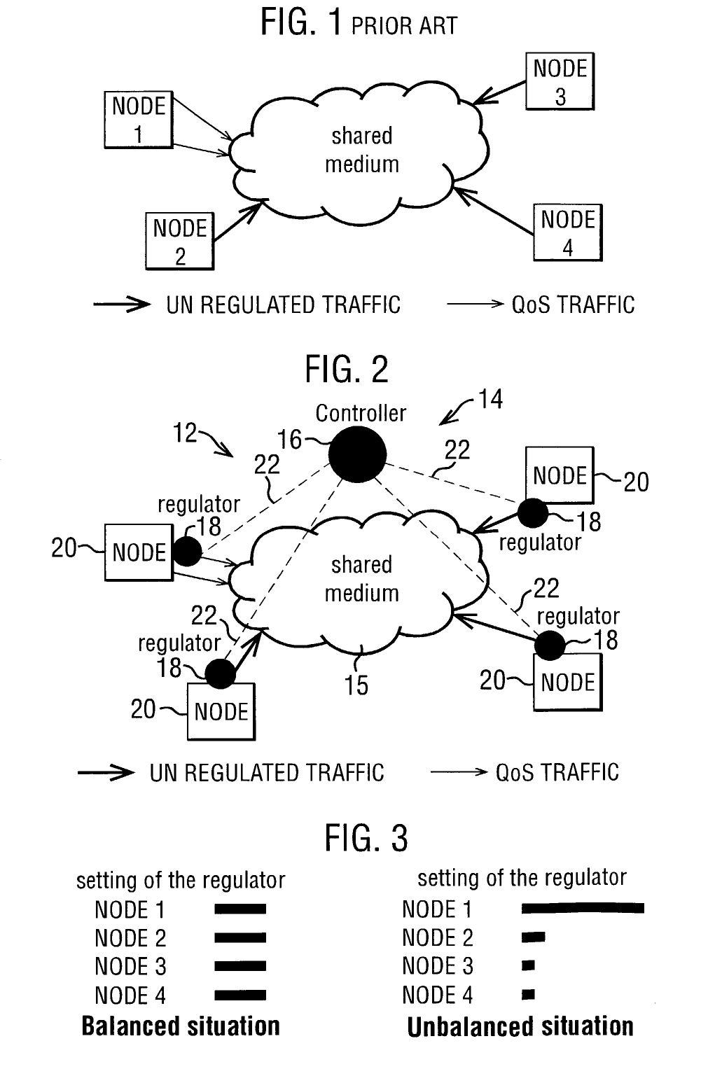

### DETAILED DESCRIPTION

There is a mechanism to regulate the best effort traffic at the source (i.e. at the node). This requires that there are provisions in the network to control the amount of QoS traffic that is allowed within the network. As shown in FIG. 2 an example of such a provision is an admission control server 12 that restricts the QoS traffic in a network 14 including a shared medium 15 according to the network capacity. QoS traffic is therefore not controlled nor affected. The shared medium can be, for example, shared Ethernet (CSMA/CD) or wireless Local Area Network (LAN) (CSMA/CA).

The admission controller 12 involves a central controller 16, regulators 18 at all nodes 20 and control messages 22 between the regulators 18 and the central controller 16.

Each node 20 is equipped with a regulator 18, which controls the amount of best effort traffic that is allowed to be sent by the node. The regulators 18 are centrally operated by the controller 16 , which has knowledge about the current amount of QoS traffic and the total network capacity of the shared medium at any time. The controller 16 distributes the available network capacity that can be used for best effort traffic (total capacity minus present QoS traffic) among the nodes 20 which are active and controls the regulators 18 accordingly by sending control messages 22 to the regulators 18.

The regulators 18 inform the controller 16 on a regular basis about the amount of best effort traffic that is waiting to be transmitted. The controller 16 takes this into account when determining the setting (i.e. the amount of best effort traffic allowed to be sent) of each regulator 18 . The controller 16 sends, with the same regular interval, control messages 22 containing the current setting to the regulators 18.

When a particular node has a lot of data to send compared to the other nodes, the controller 16 assigns a larger share of the available bandwidth to that node. This is illustrated in FIG. 3 for both balanced (i.e. equal) and unbalanced (i.e. unequal) load situations. In a balanced situation, the regulators 18 at each node 20 allow the same maximum of best effort traffic per unit time to be sent. In an unbalanced situation the regulators 18 have different settings. For example, as illustrated in FIG. 3 node 1 can send more best effort traffic per unit time than node 2 which can send more than node 3 or node 4.

In some embodiments, the messaging protocols between regulators 18 and controller 16 could be standardised.

1. A telecommunications network comprising a plurality of nodes and a controller operative to control levels of best-effort traffic transmitted from nodes so as to keep bandwidth available for traffic sent with a predetermined quality of service.

2. A telecommunications network according to claim 1, in which at least some nodes include a respective regulator of best effort traffic, said regulators being controlled by best-effort traffic level control signals sent by the controller.

3. A telecommunications network according to claim 2, in which at least substantially all nodes include a respective regulator of best effort traffic, said regulators being controlled by best-effort traffic level control signals sent by the controller.

4. A telecommunications network according to claim 2, in which the regulators are controlled by a common best-effort traffic level control signal so as to set the maximum level of best-effort traffic sent per unit time by their respective nodes to be the same level.

5. A telecommunications network according to claim 2, in which the regulators are controlled by respective best-effort traffic level control signals so as to set the maximum level of best-effort traffic which can be sent per unit time dependent on the amounts of data waiting at nodes to be sent.

6. A telecommunications network according to claim 2, in which the control signals are sent at regular intervals.

7. A telecommunications network according to claim 1, which is a shared Ethernet network.

8. A telecommunications network according to claim 1, which is a wireless local area network.

9. A method of controlling levels of best-effort traffic transmitted from nodes in a telecommunications network so as to keep bandwidth available for traffic sent with a predetermined quality of service by providing a controller of best-effort traffic levels.

10. A method according to claim 9, in which the controller sends control signals to the nodes, the nodes being provided with regulators controlled by the control signals and operative to limit the level of best-effort traffic per unit time sent by the respective node.

11. A network node for a telecommunications network, the node comprising a regulator operative under the control of a received control signal to limit the level of best-effort traffic sent by the node per unit time so as to keep bandwidth available for traffic to be sent with a predetermined quality of service.
